(19) United States
(12) Patent Application Publication
(10) Pub. No.: US 2017/0329301 A1
(43) Pub. Date: Nov. 16, 2017

(54) Home Automation Hybrid Universal Switch and Remote

(71) Applicants: David R. Hall, Provo, UT (US); Clint Cook, American Fork, UT (US); Davido Hyer, Spanish Fork, UT (US)

(72) Inventors: David R. Hall, Provo, UT (US); Clint Cook, American Fork, UT (US); Davido Hyer, Spanish Fork, UT (US)

(21) Appl. No.: 15/151,073

(22) Filed: May 10, 2016

(51) Int. Cl. G05B 19/10; H04L 12/28; G08C 17/02

(52) U.S. Cl. CPC G05B 19/104; G08C 17/02; H04L 12/2809

(57) ABSTRACT

An apparatus is disclosed that includes a battery-operated switch magnetically mounted to a switch holder. The switch includes a microcontroller, a short-range wireless transmitter, one or more tactile control buttons, and a switch magnet. The switch holder includes a magnetic plate, a front face having a front height and front width, a back plane having a back height and a back width, and a depth spanning from the front face to the back plane. The switch holder also includes a switch depression in the front face spanning at least a portion of the depth. The switch depression has a shape that correlates to a switch shape, and the switch depression has dimensions that correlate to switch dimensions. The switch is magnetically mounted to the magnetic holder in the switch body depression by the switch magnet and the magnetic plate.

### TECHNICAL FIELD

This invention relates generally to the field of home automation, and more specifically to remotes and switches for home automation.

### BACKGROUND

Home and office automation is an exploding market with dozens of manufacturers offering hundreds of products. Products and solutions range from customizable room lighting to smart door locks, and even adaptive thermostats. In many ways, though, while manufacturers in the home and office automation market have taken advantage of new and emerging technologies, such as wireless communication networks, machine learning and mobile device applications and networks, such solutions overlook many of the practicalities of how people already use, and are accustomed to using, home and office technologies. User experience puts limits on market acceptance and adoption of home and office automation. Thus, improvements in home and office automation user experience are needed.

### SUMMARY OF THE INVENTION

A home automation hybrid universal switch and remote (herein “universal switch”) is disclosed that overcomes or improves upon the limitations discussed above. In general, the universal switch includes a short-range wireless transmitter and a microcontroller, and a magnet for mounting the universal switch to a switch holder. The switch holder includes a magnet for holding the switch, and is, in some embodiments, mounted to a wall similar to a light switch. As one example, the switch holder is the same shape and size as a single-gang standard face plate, and the universal switch is the same shape as a standard rocker light switch.

The general embodiment described above improves a user's experience using a home automation system. The universal switch and switch holder utilize features users are already accustomed to while integrating novel features of home automation. This increases likelihood of user acceptance and adoption, and ultimately maximizes market penetration of home automation systems.

In one embodiment, an apparatus is disclosed that includes a battery-operated switch. The switch includes a microcontroller having instructions that control operation of an electrical device, a short-range wireless transmitter, and one or more tactile control buttons. The tactile control buttons trigger the microcontroller to execute at least a portion of the instructions and transmit the executed portion of the instructions to control the electrical device. The switch also includes a switch magnet. The apparatus further includes a switch holder, which includes a magnetic plate, a front face having a front height and front width, a back plane having a back height and a back width, and a depth spanning from the front face to the back plane. The switch holder also includes a switch depression in the front face spanning at least a portion of the depth. The switch depression has a shape that correlates to a switch shape, and the switch depression has dimensions that correlate to switch dimensions. The magnetic plate is adjacent to the switch depression. The switch holder also includes one or more sloped depressions sloping into the front face spanning at least a portion of the depth and adjacent to the switch body depression. The switch is magnetically mounted to the switch holder in the switch body depression by the switch magnet and the magnetic plate.

In another embodiment, an apparatus is disclosed that includes a battery-operated switch. The switch includes a microcontroller having instructions that control operation of an electrical device, a short-range wireless transmitter, and one or more tactile control buttons. The tactile control buttons trigger the microcontroller to execute at least a portion of the instructions and transmit the executed portion of the instructions to control the electrical device. The switch also includes one or more sets of LED indicator lights and a switch magnet. The apparatus further includes a switch holder, which includes a magnetic plate, a front face having a front height and front width, a back plane having a back height and a back width, and a depth spanning from the front face to the back plane. The switch holder also includes a switch depression in the front face spanning at least a portion of the depth. The switch depression has a shape that correlates to a switch shape, and the switch depression has dimensions that correlate to switch dimensions. The magnetic plate is adjacent to the switch depression. The switch holder also includes one or more sloped depressions sloping into the front face spanning at least a portion of the depth and adjacent to the switch body depression. The switch is magnetically mounted to the switch holder in the switch body depression by the switch magnet and the magnetic plate.

### BRIEF DESCRIPTION OF THE DRAWINGS

A more particular description of the invention briefly described above is made below by reference to specific embodiments. Several embodiments are depicted in drawings included with this application, in which:

FIGS. 1A-C depict several views of an embodiment of a universal switch;

FIG. 2 depicts another embodiment of a universal switch assembly;

FIG. 3 depicts an embodiment of a universal switch assembly with a hybrid universal switch and remote;

FIGS. 4A-B depict views of an embodiment of a hybrid universal switch and remote;

FIGS. 5A-B depict a top and back-inside view of a switch holder;

FIG. 6 depicts a user using a battery-operated universal switch;

FIG. 7 depicts an example embodiment of a hybrid universal switch and remote network, in which the universal switch acts as a switch; and

FIG. 8 depicts an example embodiment of a hybrid universal switch and remote network, in which the universal switch acts as a remote.

### DETAILED DESCRIPTION

A detailed description of the claimed invention is provided below by example, with reference to embodiments in the appended figures. Those of skill in the art will recognize that the components of the invention as described by example in the figures below could be arranged and designed in a wide variety of different configurations. Thus, the detailed description of the embodiments in the figures is merely representative of embodiments of the invention, and is not intended to limit the scope of the invention as claimed.

In some instances, features represented by numerical values, such as dimensions, mass, quantities, and other properties that can be represented numerically, are stated as approximations. Unless otherwise stated, an approximate value means “correct to within 50% of the stated value.” Thus, a length of approximately 1 inch should be read “1 inch+/−0.5 inch.”

All or part of the present invention may be embodied as a system, method, and/or computer program product. The computer program product may include a computer readable storage medium (or media) having computer readable program instructions thereon for causing a processor to carry out aspects of the present invention. For example, the computer program product may include firmware programmed on a microcontroller.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, a chemical memory storage device, a quantum state storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming languages such as Smalltalk, C++ or the like, and conventional procedural programming languages such as the “C” programming language or similar programming languages. Computer program code for implementing the invention may also be written in a low-level programming language such as assembly language.

In some embodiments, electronic circuitry including, for example, programmable logic circuitry, field-programmable gate arrays (FPGA), or programmable logic arras (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. Those of skill in the art will understand that each block of the flowchart illustrations and/or block diagrams, and combinations of blocks in the flowchart illustrations and/or block diagrams, may be implemented by computer readable program instructions. Additionally, those of skill in the art will recognize that the system blocks and method flowcharts, though depicted in a certain order, may be organized in a different order and/or configuration without departing from the substance of the claimed invention.

These computer readable program instructions may be provided to a processor of a general purpose computer, special purpose computer, embedded system, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

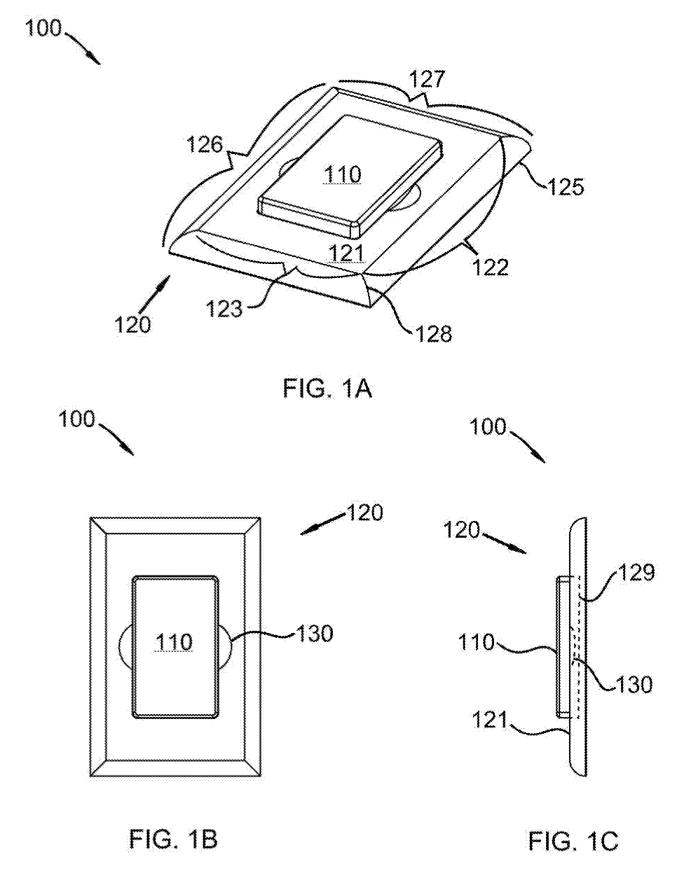

FIGS. 1A-C depict several views of an embodiment of a universal switch. FIG. 1A is an isometric view of universal switch assembly 100. Universal switch assembly 100 includes battery-operated switch 110 magnetically mounted to switch holder 120. Switch holder 120 includes a front face 121 having a front height 122 and a front width 123, and a back plane 125 having a back height 126 and a back width 127. Front face 121 is, in some embodiments, a solid monolithic surface. Similarly, in some embodiments, back plane 125 is a solid monolithic surface. However, in some embodiments, back plane 125 is an imaginary plane parallel to front face 121 and spanning between top and side back portions of switch holder 120. The dimensions of front height 122 and front width 123 range from a standard single-gang wall plate to a jumbo four-gang, or even ten-gang wall plate. For example, in some embodiments, front height 122 ranges from 1 inch to 5 inches, front width 123 ranges from 0.5 inch to 8 inches, back height 126 ranges from 1 inch to 5 inches, and back width 127 ranges from 0.5 inch to 8 inches. In some cases, it is beneficial to include beveling 128 between back plane 125 and front face 121. In one specific example, beveling 128 is a quarter-inch bevel. The dimensions of back height 126 and back width 127 are standard single-gang dimensions, and the dimension of front height 122 and front width 123 are reduced proportionally by the quarter-inch bezel.

FIG. 1B is a top view of universal switch assembly 100, including battery-operated switch 110 and switch holder 120 having sloped depressions 129. FIG. 1C is a side view of universal switch assembly 100, including battery-operated switch 110 and switch holder 120 having front face 121 and back plane 125. Switch holder 120 additionally includes switch depression 129 in front face 121 and sloped depressions 130 sloping into front face 121. Switch depression 129 has similar dimensions as battery-operated switch 110 so that battery-operated switch 110 can be placed in switch depression 129 and held by switch holder 120. Sloped depressions 130 are adjacent to switch depression 129 and provide additional surface area on battery-operated switch 110 for a user to grasp battery-operated switch 110 and remove it from switch holder 120.

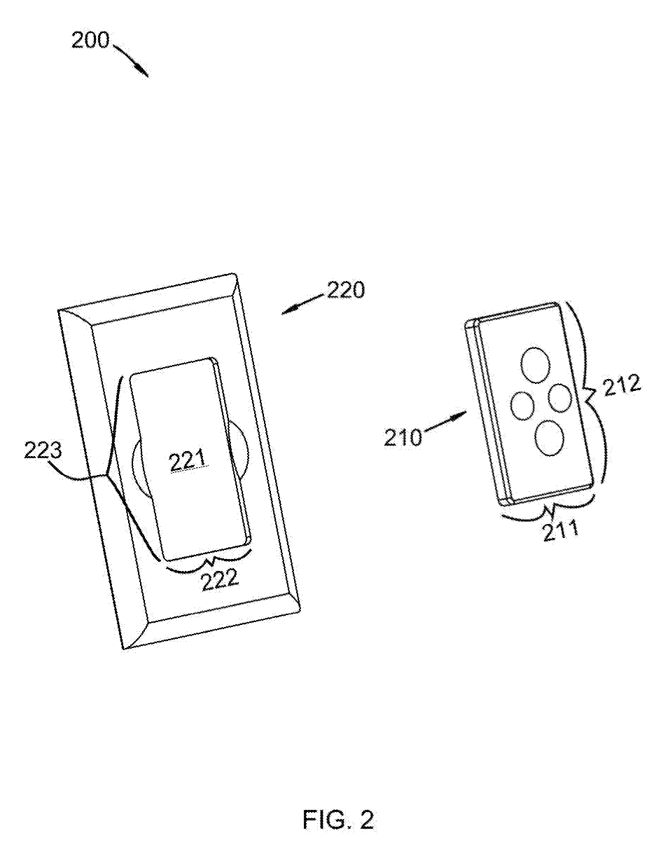

FIG. 2 depicts another embodiment of a universal switch assembly. Universal switch assembly 200 includes battery-operated switch 210 and switch holder 220. Battery-operated switch 210 has switch width 211 and switch height 212. In some embodiments, switch width 211 ranges from 0.5 inch to 2 inches, and switch height 212 ranges from 1 inch to 3 inches. In a specific embodiment, switch width 211 is 1¼ inch and switch height 212 is 2⅝ inches. Switch depression 221 has a shape that correlates to a battery-operated switch 210 shape. For example, in one embodiment battery-operated switch 210 and switch depression 221 are rectangular. Additionally, switch depression 221 has dimensions, such as switch depression width 222 and switch depression height 223, that correlate to switch 210 dimensions, such as switch width 211 and switch height 212. Thus, in some embodiments, switch depression width 222 ranges from 0.5 inch to 2 inches, and switch depression height 223 ranges from 1 inch to 3 inches. In a specific embodiment, switch depression width 222 is 1¼ inch and switch depression height 223 is 2⅝ inches.

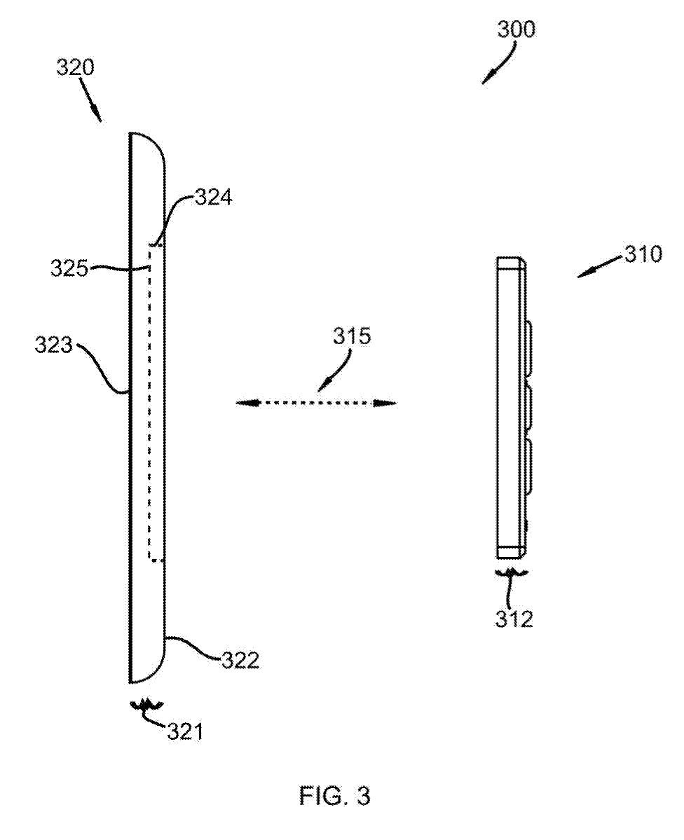

FIG. 3 depicts an embodiment of a universal switch assembly with a hybrid universal switch and remote. Universal switch assembly 300 includes battery-operated switch 310 physically separated 315 from switch holder 320. Switch 310 has switch depth 312. In some embodiments, switch depth 312 ranges from 0.1 inch to 0.75 inch. In a specific embodiment, switch depth 312 is ⅜ inch. Switch holder 320 has switch holder depth 321 spanning from front face 322 to back plane 323. In some embodiments, switch holder depth 321 ranges from 0.1 inch to 1 inch. In a specific embodiment, switch holder depth 321 is ⅛ inch. Switch depression 324 spans at least a portion of switch holder depth 321. In some embodiments, switch depression bottom 325 is flush with back plane 323. Additionally, as depicted, switch depression bottom 325 is parallel to back plane 323. However, in some embodiments, switch depression bottom 325 is oblique to back plane 323.

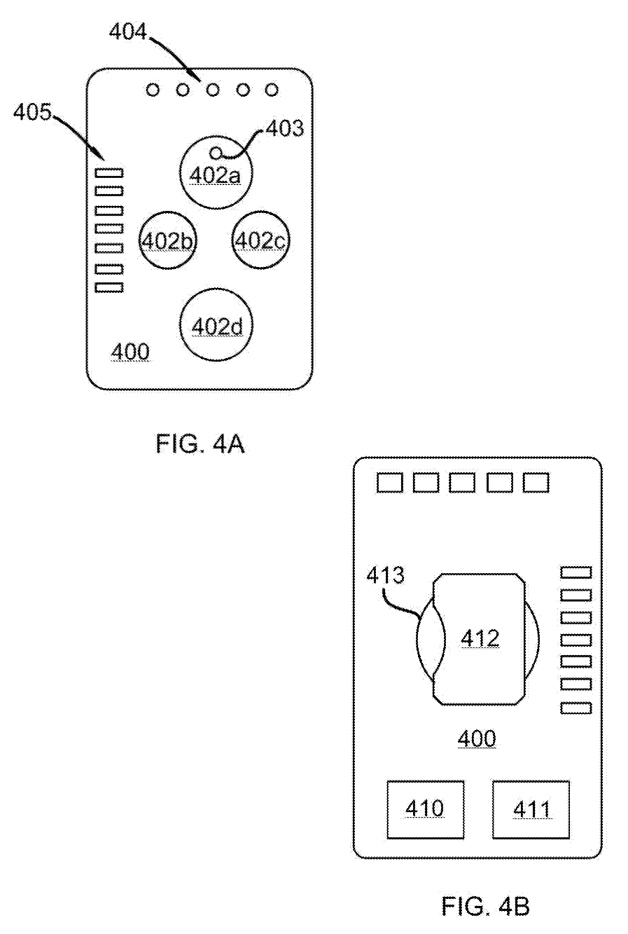

FIGS. 4A-B depict views of an embodiment of a hybrid universal switch and remote. FIG. 4A depicts a top view of switch 400. Switch 400 includes one or more tactile control buttons 402. Tactile control buttons 402 are arranged in a variety of shapes on Switch 400. For example, in one embodiment, four tactile control buttons 402a-d are arranged in a diamond pattern. Additionally, tactile control button 402a includes raised portion 403 that indicates to a user, via touch, an orientation of switch 400 relative to the user. For example, by touching raised portion 403, the user can determine whether switch 400 is oriented away from the user or towards the user. Raised portion 403 also indicates to a user, via touch, a button identity associated with tactile control button 402a. For example, by touching raised portion 403, the user can determine the user is touching tactile control button 402a and, in some cases, the identity of surrounding tactile control buttons 402b-d.

Switch 400 also includes LED indicator lights 404, 405. LED indicator lights 404 are aligned parallel to a top portion of switch 400. In some embodiments, LED indicator lights 404 consist of a number of lights ranging from one to ten lights. In the specific embodiment depicted, LED indicator lights 404 consist of 5 LED lights. LED indicator lights 404 indicate to a user one or more groups of devices selected for control by switch 400. The groups of devices include, in some embodiments, one or more of room lights, ceiling fans, window blinds, or thermostats. For example, in one embodiment, one of LED indicator lights 404 represents a group of room lights, another of LED indicator lights 404 represents a group of ceiling fans, yet another of LED indicator lights 404 represents window blinds, and another of LED indicator lights 404 represents a thermostat. A user presses tactile control button 402b or tactile control button 402c to select a group of devices, and a corresponding LED indicator light indicates the group is selected by lighting.

LED indicator lights 405 are aligned parallel to a side portion of switch 400. In some embodiments, LED indicator lights 405 consist of a number of lights ranging from three to ten lights. In the specific embodiment depicted, LED indicator lights 405 consist of 7 LED lights. LED indicator lights 405 indicate to a user a selected-device operation level. For example, in one embodiment, LED indicator lights 404 indicate a group of room lights is selected. LED indicator lights 405 indicate to a user a brightness setting of the room lights. Such indication is done in some embodiments by lighting a number of LED indicator lights 405 associated with the brightness setting. In cases where the room lights are at a highest brightness setting, all of LED indicator lights 405 are lit; in cases where the room lights are at a lowest brightness setting, only one LED indicator light 405 is lit; and in cases where the room lights are at a medium brightness setting, half of LED indicator lights 405 are lit.

FIG. 4B depicts an inside view of switch 400. Switch 400 includes microcontroller 410 having instructions that control operation of an electrical device, such as those described above with regard to FIG. 4A, short-range wireless transmitter 411, switch magnet 412, and battery 413. Microcontroller 410 also includes instructions for operating switch 400. One or more tactile control buttons, such as tactile control buttons 402 in FIG. 4A, trigger microcontroller 410 to execute at least a portion of the instructions for operating switch 400. Additionally, the tactile control buttons trigger microcontroller 410 to execute at least a portion of the instructions for the electrical device and transmit, via transmitter 411, the executed portion of the instructions to control the electrical device. For example, in one embodiment, a user pushes a tactile control button to select control instructions for an electrical device. Microcontroller 410 selects control instructions associated with the electrical device. While the control instructions associated with the electrical device are selected, the user presses another tactile control button to control the electrical device. Microcontroller 410 transmits to the electrical device, via transmitter 411, the control instructions.

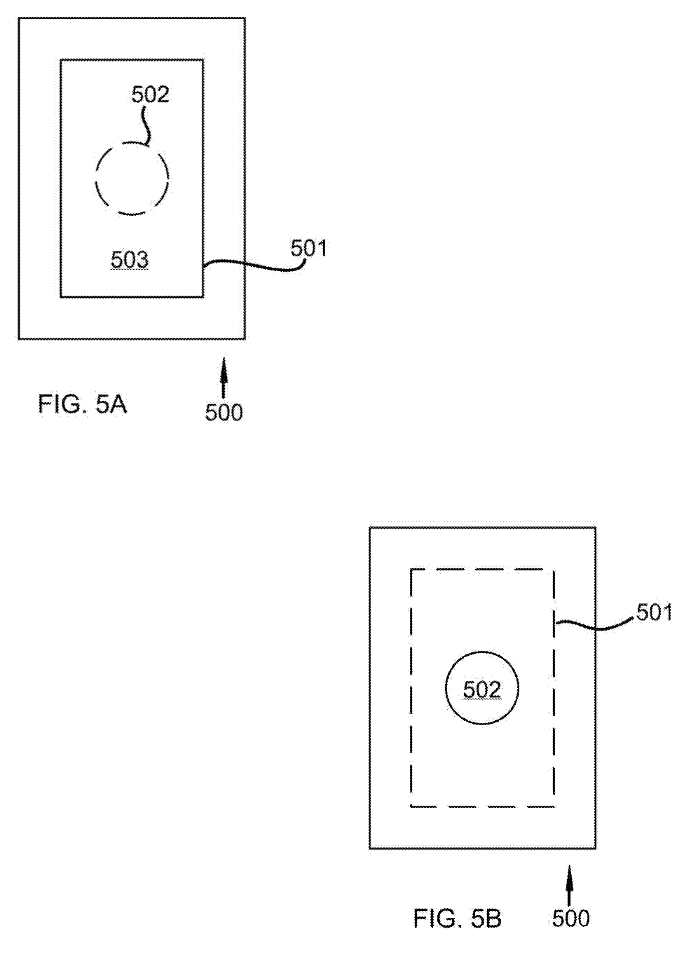

FIGS. 5A-B depict a top and back-inside view of a switch holder. FIG. 5A is a top view of switch holder 500, and FIG. 5B is a back inside view of switch holder 500. Switch holder 500 includes switch depression 501 and magnetic plate 502. As depicted, magnetic plate 502 is adjacent to switch depression 501 behind switch depression bottom 503. When brought together, a switch, such as switch 400 described above with regard to FIGS. 4A-B, is magnetically mounted to switch holder 500 in switch depression 501 by the switch magnet and magnetic plate 502.

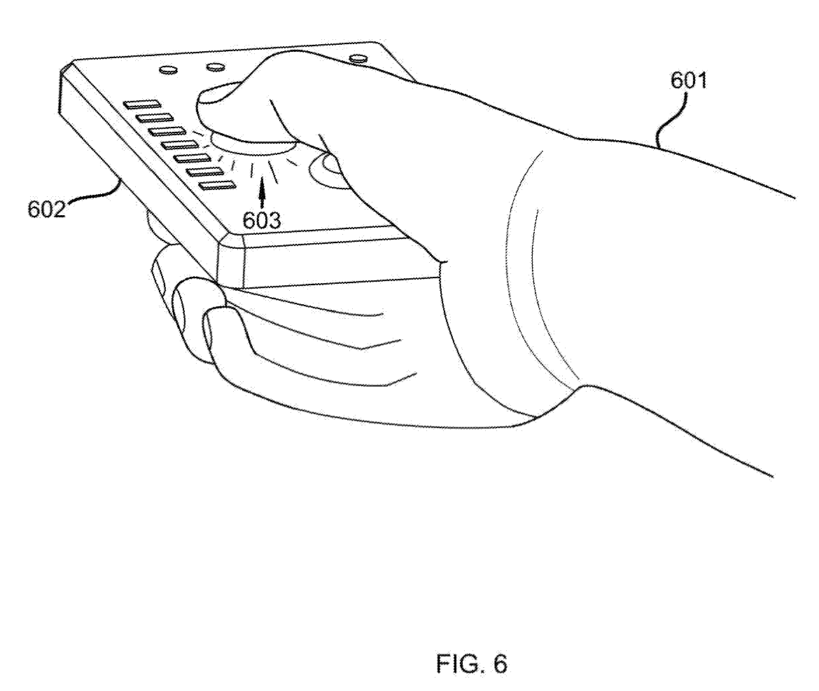

FIG. 6 depicts a user using a battery-operated universal switch. In the depicted embodiment, user 601 presses a tactile control button of switch 602. The tactile control button gives physical response 603 to user 601 when the user presses the tactile control button notifying user 601 the tactile control button is pressed. In one embodiment, physical response 603 includes a tactile click user 601 feels as the tactile control button is pressed. In another embodiment, physical response 603 includes an audible sound user 601 hears as the tactile control button is pressed. In some embodiments, physical response 603 includes the tactile click and the audible sound.

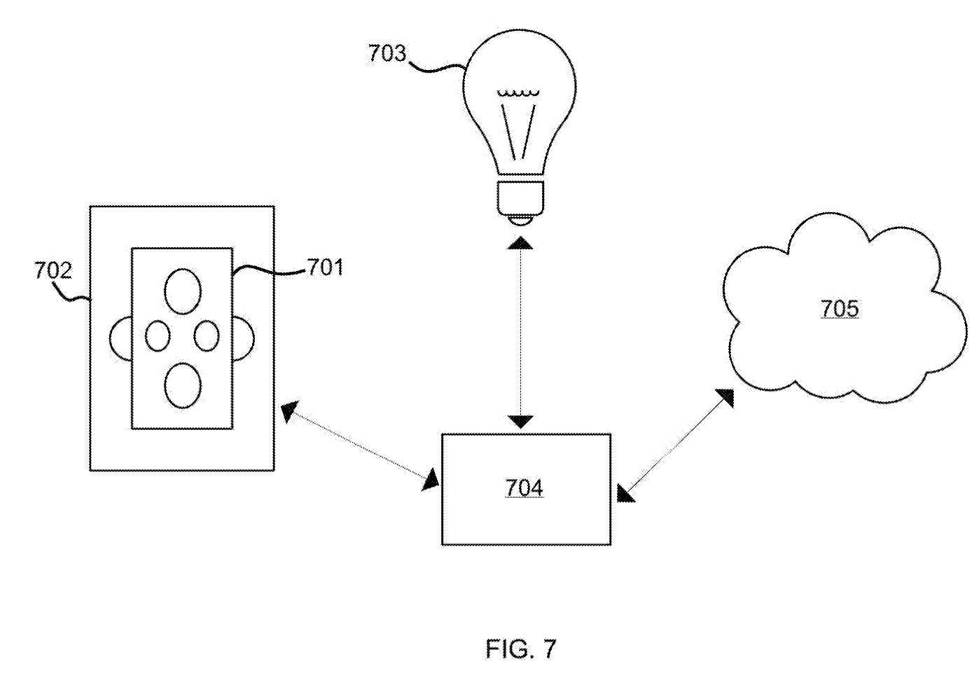

FIG. 7 depicts an example embodiment of a hybrid universal switch and remote network, in which the universal switch acts as a switch. Switch 701 is magnetically mounted to switch holder 702, which is mounted to a wall in a manner and location similar to a standard single-gang light switch and face plate. Switch 701 communicates instructions for electrical device 703 via hub 704. For example, in one embodiment, electrical device 703 is a room light. A user presses a tactile control button on switch 701 to increase the light's brightness. Switch 701 sends, via a Bluetooth signal, instructions to hub 704 to increase the light's brightness. Hub 704, in turn, sends the instructions to the light. In some embodiments, hub 704 will additionally update server 705, such as a server that is part of a cloud of servers, notifying the user that the instructions were sent and/or executed by electrical device 703. In one embodiment, electrical device 703 malfunctions, for example, by operating as a strobe light instead of romantic mood lighting, and sends a malfunction notification to hub 704. Hub 704 notifies the user, via server 705, that electrical device 703 is malfunctioning.

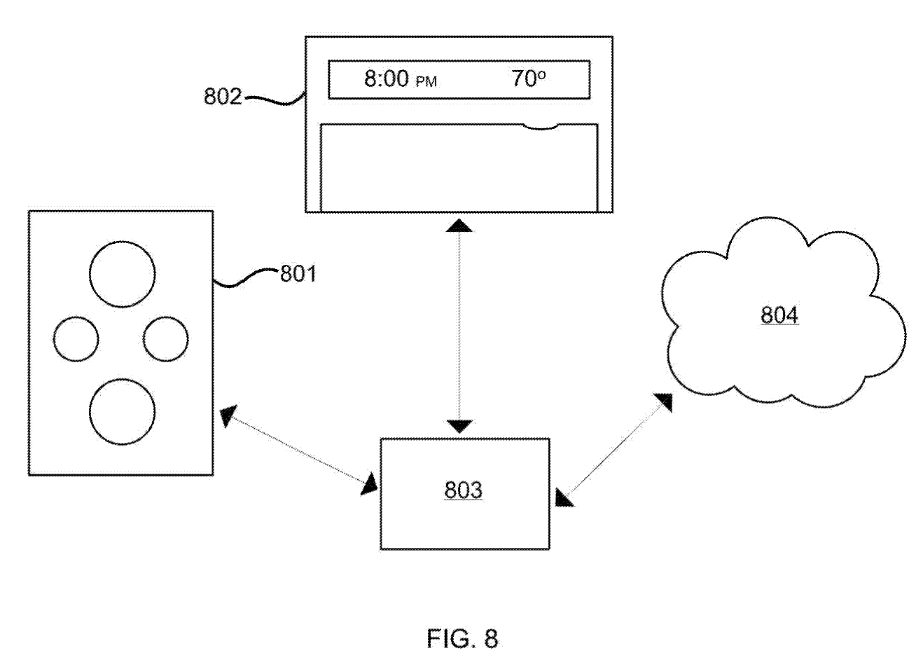

FIG. 8 depicts an example embodiment of a hybrid universal switch and remote network, in which the universal switch acts as a remote. Remote switch 801 communicates instructions for electrical device 802 via hub 803. For example, in one embodiment, electrical device 802 is a thermostat. A user presses a tactile control button on remote switch 801 to increase a room temperature controlled by the thermostat through an HVAC system. Remote switch 801 sends, via a Bluetooth signal, instructions to hub 803 to increase the room temperature. Hub 803, in turn, sends the instructions to the thermostat. In some embodiments, hub 803 will additionally update server 804, such as a server that is part of a cloud of servers, notifying the user that the instructions were sent and/or executed by electrical device 802. In one embodiment, electrical device 802 malfunctions, for example, by turning a living room into a sauna, and sends a malfunction notification to hub 803. Hub 803 notifies the user, via server 804, that electrical device 802 is malfunctioning.

1. An apparatus comprising:
a battery-operated switch comprising:
a microcontroller having instructions that control operation of an electrical device;
a short-range wireless transmitter;
one or more tactile control buttons that trigger the microcontroller to execute at least a portion of the instructions and transmit the executed portion of the instructions to control the electrical device; and
a switch magnet; and
a switch holder comprising:
a magnetic plate;
a front face having a front height and a front width, wherein dimensions of the front height range from 1 inch to 5 inches and dimensions of the front width range from 0.5 inch to 8 inches;
a back plane having a back height and a back width, wherein dimensions of the back height range from 1 inch to 5 inches and dimensions of the back width range from 0.5 inch to 8 inches;
a depth spanning from the front face to the back plane;
a switch depression in the front face spanning at least a portion of the depth, wherein the switch depression has a shape that correlates to a switch shape, wherein the switch depression has dimensions that correlate to switch dimensions, and wherein the magnetic plate is adjacent to the switch depression; and
two opposing semi-circular concave depressions, each comprising an open end and a closed end, each laterally disposed on opposite sides of the switch depression, the closed end sloping toward the open end, and the open end intersecting the switch depression and being adjacent the switch,
wherein the switch is magnetically mounted to the switch holder in the switch depression by the switch magnet and the magnetic plate.

2. The apparatus of claim 1, wherein the electrical device is one or more of a room light, a ceiling fan, a set of window blinds, or a thermostat.

3. (canceled)

4. The apparatus of claim 1, wherein the switch dimensions range from 0.5-inch wide by 1-inch high by 0.1-inch deep to 2-inches wide by 4-inches high by 0.75-inch deep.

5. The apparatus of claim 1, wherein the switch dimensions are 1¼-inch wide by 2⅝-inches high by ⅜-inch deep.

6. The apparatus of claim 1, wherein the switch depression dimensions range from 0.5-inch wide by 1-inch high by 0.1-inch deep to 2-inches wide by 3-inches high by 0.75-inch deep.

7. The apparatus of claim 1, wherein the switch depression dimensions are 1¼-inch high by 2⅝-inches high by ⅛-inch deep.

8. The apparatus of claim 1, wherein the switch comprises four tactile control buttons arranged in a diamond pattern.

9. The apparatus of claim 1, wherein at least one of the one or more tactile buttons comprises a raised portion that indicates to a user, via touch, an orientation of the switch relative to the user, and wherein the raised portion indicates to a user, via touch, a button identity associated with the at least on tactile control button.

10. The apparatus of claim 1, wherein one or more of the tactile buttons gives a physical response to a user when the user presses the tactile buttons notifying the user the button is pressed.

11. The apparatus of claim 1, wherein the physical response comprises a tactile click.

12. The apparatus of claim 1, wherein the physical response is an audible sound.

13-20. (canceled)
